(19) United States
(12) Patent Application Publication
(10) Pub. No.: US 2004/0191508 A1
(43) Pub. Date: Sep. 30, 2004

(54) Peel-and-stick installation method for thermoplastic-type covering systems

(76) Inventors: Michael J. Hubbard, Maumee, OH (US); James E. Burkett, Perrysburg, OH (US); Brian S. Alexander, Toledo, OH (US)

Correspondence Address: David G. Burleson, Chief Intellectual Property Counsel, OMNOVA Solutions, Inc., 175 Ghent Road, Fairlawn, OH, 44333, US

(21) Appl. No.: 10/775,206

(22) Filed: Feb. 11, 2004

Related U.S. Application Data
(60) Provisional application No. 60/446,283, filed on Feb. 11, 2003.
(60) Provisional application No. 60/446,277, filed on Feb. 11, 2003.

(51) Int. Cl. B32B 33/00

(52) U.S. Cl. 428/343; 428/41.8; 156/60

(57) ABSTRACT

The present invention provides a pre-applied covering product for a building structure including an attached fabric layer coated with an adhesive.

### CROSS-REFERENCE TO RELATED APPLICATION

This application claims the benefit of U.S. Provisional Application No. 60/446,277, filed Feb. 11, 2003, and U.S. Provisional Application No. 60/446,283, filed Feb. 11, 2003, the entire disclosure and contents of which is hereby incorporated by reference.

### BACKGROUND OF THE INVENTION

The present invention relates generally to covering systems for building structures.

Thermoplastic covering membranes of a covering system for building structures are typically installed using some combination of mechanical fasteners, adhesives applied to the covering membrane and/or the building structure to be covered on-site, and hot air. For example, when the building structure is a roof deck, mechanical fasteners, such as screw and plate combinations are used to hold covering systems comprising roofing membranes to the roof deck at the edges of the roofing membranes. To hold a roofing membrane to a roof deck, adhesives are typically applied to the roofing membranes and/or roof deck at the site of the roofing installation. Generally, an adhesive is applied to a roofing membrane and/or substrate and allowed to set before the membrane is rolled out to adhere the membrane to the substrate. Because an adhesive must be applied on-site and allowed to set, adhering a roofing membrane to a roofing substrate may require a considerable degree of skill and time to perform. To join two roofing membranes that have been adhered to a roof deck, usually hot air is used to weld seams where the two membranes overlap. The seam welds are usually formed using hot air welders that typically cost several thousands of dollars, making the installation of conventional roofing systems quite expensive, even for professional installers.

Roofing peripherals, such as pipe boots, walkway pads and flashing, that are adhered to roofing membranes in a roofing system using an adhesive or a hot air weld applied to the peripheral at the site of the roofing system installation. This requires a professional installer to have some degree of skill in working with adhesives and hot air weld devices.

### SUMMARY OF THE INVENTION

The present invention overcomes the shortcomings of prior methods of weatherproofing building structures by providing a covering system that may be installed easily and quickly by a non-professional without special tools.

It is another object of the present invention to provide a peel-and-stick roofing flashing that may be used in a variety of covering systems for building structures.

According to a first broad aspect of the present invention, there is provided a covering product comprising: a membrane comprised of a thermoplastic; and a dead load shear capable adhesive on at least a portion of a backside of the membrane in a quantity sufficient to adhere a majority of the membrane to a building structure.

According to second broad aspect of the invention, there is provided a method for installing a covering system comprising the following steps: (a) providing a substrate; and (b) adhering a first membrane to a building structure using a first adhesive bonded to at least a portion of a backside of the first membrane, wherein the first membrane is comprised of a thermoplastic and the first adhesive comprises a dead load shear capable adhesive and wherein a majority of the surface area of the first membrane is adhered to the building structure.

According to third broad aspect of the invention, there is provided a covering product comprising: a universal flashing; and a dead load shear capable adhesive on at least a portion of a backside of the universal flashing in a quantity sufficient to adhere a majority of the universal flashing to a building structure or a thermoplastic membrane.

According to a fourth broad aspect of the invention, there is provided a method for installing a flashing comprising: providing a universal flashing; and adhering the universal flashing to at least two surfaces that are at angle to each other, wherein the flashing is adhered to a building structure and/or a membrane adhered to the building structure

### BRIEF DESCRIPTION OF THE DRAWINGS

The invention will be described in conjunction with the accompanying drawings, in which:

FIG. 1 illustrates in simplified form a section of a peel-and-stick roofing system constructed in accordance with a preferred embodiment of the invention;

FIG. 2 is a cross-sectional view of one embodiment of a flashing of the present invention;

FIG. 3 is a cross-sectional view of another embodiment of a flashing of the present invention;

FIG. 4 is a cross-sectional view of another embodiment of a flashing of the present invention;

FIG. 5 is a perspective view of an embodiment in which a universal flashing is used in conjunction with two building structure surfaces that meet at right angles;

FIG. 6 is a perspective view of an embodiment in which a universal flashing is used in conjunction with an exterior corner of a building structure;

FIG. 7 is a perspective view of an embodiment in which a universal flashing is used in conjunction with an interior corner of a building structure;

FIG. 8 illustrates in simplified form a section of a peel-and-stick covering system constructed in accordance with a preferred embodiment of the invention in which a covering system is applied to the underside of the upper interior portion of a tunnel.

### DETAILED DESCRIPTION

It is advantageous to define several terms before describing the invention. It should be appreciated that the following definitions are used throughout this application.

Where the definition of terms departs from the commonly used meaning of the term, applicant intends to utilize the definitions provided below, unless specifically indicated.

The term “building structure” refers to any building, portion of a building or other structure made of construction materials that is exposed to the elements, i.e. rain, wind, water, ice, snow, sun, etc. on a regular basis. Examples of building structures include roofs, building walls, free standing walls, sheds, chimneys, exposed pipes, culverts, above ground or underground tunnels, etc. Examples of construction materials include masonry materials such stone, brick, concrete, etc., wood, metal, insulation, plaster, plasterboard, etc.

The term “weather proofing” refers to the conventional meaning of the term weatherproofing i.e. protecting building structures such as roofs, chimneys, walls, etc. from the elements, i.e. rain, wind, water, ice, snow, sun.

The term “construction materials” refers to typical materials used in construction such as wood, brick, concrete, metal, insulation materials, etc.

The term “majority of a membrane” refers to more than half of the surface area of a membrane. The majority of a membrane includes one adhesive on its surface to allow the membrane to be adhered to a building structure. A second adhesive may be used to adhere the edges of the membrane to the surface of the building structure or to a second membrane overlapped by a first membrane. Also, the edges of a membrane may be left free of adhesive to allow the use of other means to fasten a membrane to a building structure.

The term “roofing membrane” refers to the conventional meaning of the term roofing membrane, i.e. a water impermeable sheet of polymeric material that is secured to a roof deck. A roofing membrane may use polymeric materials such as ethylene propylene diene terpolymer rubber (EPDM), chlorinated polyethylene, PVC, chlorosulfanated polyethylene, TPO, etc. The roofing membrane may be made from a blended composite polymer having additives, such as UV screeners, UV absorbers, fire retardants, etc. to improve weatherability.

The term “building peripheral” refers to any structure mounted on or adhered to a covering product for a building structure. Roofing peripherals are one type of common building peripheral.

The term “roofing peripheral” refers to any structure mounted on or adhered to a roofing membrane. Examples of roofing peripherals include flashing, pipe boots, walkway pads, etc.

The term “flashing” refers to pieces of material, including at least one that may be used to cover seams or joins between covering membranes or between building structures and covering membranes. Often the joins that are covered by flashings occur where two surfaces meet at an angle. One portion of flashing may be adhered to a building structure surface or to a membrane covering material, while the second portion of the flashing is adhered to a second building structure surface or covering material that is at an angle with respect to the first building structure. For example, one portion of flashing may be adhered to a flat roof and then the flashing may be bent to allow a second portion of the flashing to be adhered to a chimney extending at a 90° angle with respect to the roof. Although in most of the examples described below and shown in the drawings the flashing the two building structure surfaces form a 90° angle with respect to each other, the building surface may form other angles. For example, when the flashing is used with a roof surface and a chimney, the roof surface may be angled so that the surface of the roof and a chimney extending from the roof make an angle greater or less than 90°. Flashing may include more than two portions with multiple bends and have a variety of shapes to allow the flashing to cover particular vertical, horizontal, and angled roofs and structures associated with roofs. Flashing may be made of a flexible material, thereby allowing a sheet of flashing to be used in a variety of situations. Alternatively, flashing may be made of a material that is capable of holding a shape to allow the flashing to be used to cover particular structures. Flashing may have different shapes depending on the application. For example a piece of flashing may be round, circular, oval, square, rectangular, oblong, etc. and may include bends.

The term “semi-rigid flashing” refers to a flashing that is pre-shaped to include permanent bends that allow the semi-rigid flashing to cover a combination of surfaces such as an interior corner, an exterior corner, a bend, etc. A semi-rigid flashing when made from a thermoplastic such as EPDM may be somewhat bendable to aid in installation of the universal flashing, but after being molded, is not capable of being bent to form a permanent bend without the application of heat sufficient to melt the semi-rigid flashing material.

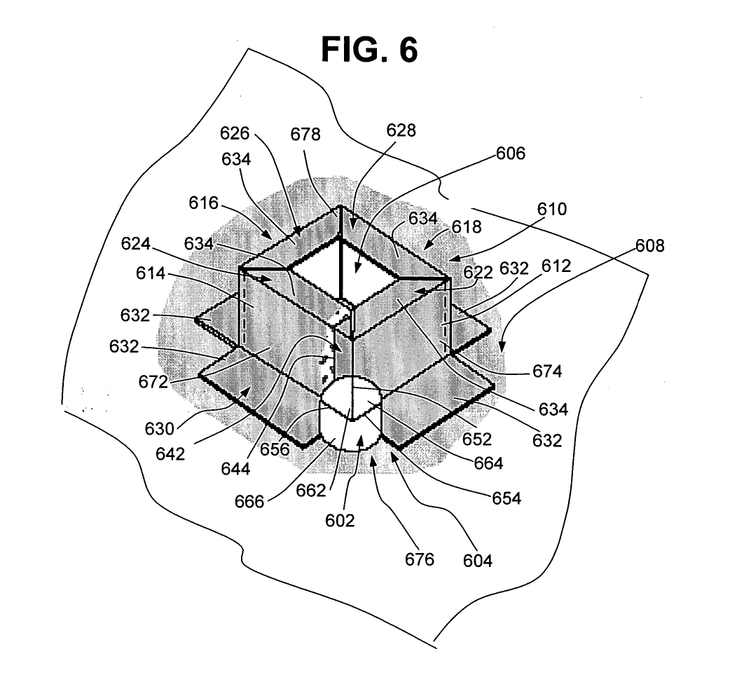

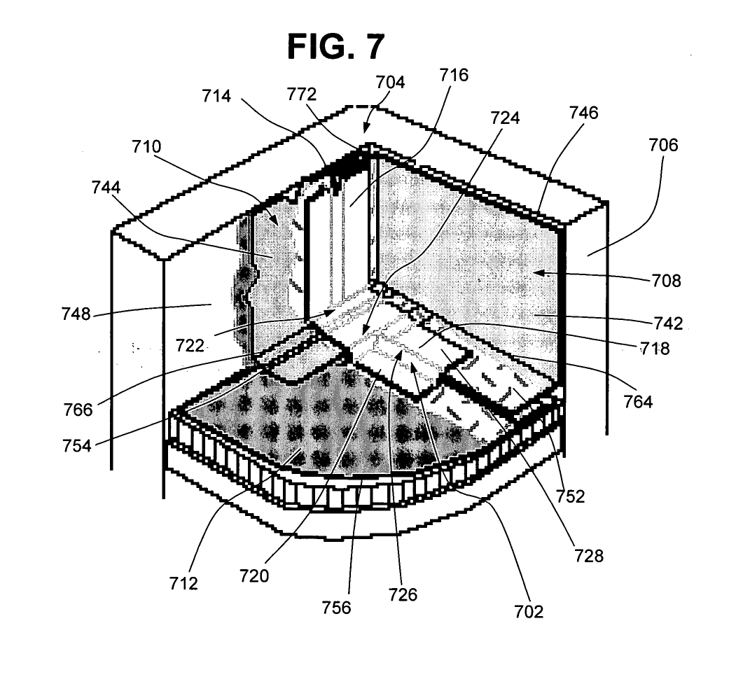

The term “universal flashing” refers to a flexible flashing that is capable of being bent from a substantially flat surface to a configuration such that the flashing has portions that are simultaneously in at least 3 orthogonal planes without requiring cuts in the flashing. For example, the multiply bent flashing shown in FIGS. 6 and 7 requires cuts in the flashing to allow the flashing to be bent, whereas the universal flashing that seals the joint between the multiply bent flashing and building structure does not. Although a universal flashing is capable of being bent simultaneously in 3 orthogonal directions to cover the exterior or interior corner of a box-like structure, for many applications, a universal flashing may extend in less than 3 orthogonal directions. For example, a universal flashing may only be need to be bent once to be adhered to two surfaces that are perpendicular with respect to each other. Also, the angles between the surfaces to which a universal flashing is adhered may be at angle more or less than 90° with respect to each other. Universal flashing may have different shapes depending on the application. For example a piece of universal flashing may be round, circular, oval, square, rectangular, oblong, etc.

The term “horizontal” surface refers to any surface that includes a horizontal dimension, i.e. extends in a direction substantially parallel with the ground. Examples of horizontal surfaces include roof substrates, roofing membranes mounted on roof substrates, etc.

The term “flexible” refers to any material that is capable of being bent, twisted, bowed, curved, etc. For example, a flexible material may be a material that is capable of being formed into a coil and capable of being unrolled from a coil to lie substantially flat. A flexible material may have the capability to be coiled in any direction. Alternatively, a flexible material may be a material that is capable of being repeatedly folded and unfolded.

The term “roof deck” refers to the conventional meaning of the term roof deck, i.e. a structural supporting surface of a building extending between the surrounding exterior walls of the building. A roof deck may be constructed from plywood, metal decking or concrete or any other suitable material or combination of materials and may include insulation material.

The term “thermoplastic” refers to the conventional meaning of thermoplastic, i.e. a compound substance that exhibits the property of a material, such as a high polymer, that softens when exposed to heat and generally returns to its original condition when cooled to room temperature. Examples of thermoplastics suitable for use include thermoplastics such as: PVC and thermoplastic polyolefins such as polyethylene (PE), linear polyethylene (LPE), polybutenes (PB), polypropylene (PP), co-polymers of polyolefins, ethylene-propylene rubber (EPR), ethylene-propylene copolymer (EPM), EPDM blended with PP or PE or copolymer, etc.

The term “room temperature thermoplastic” refers to a thermoplastic that is solid at room temperature, i.e. will not cold flow at room temperature.

The term “thermoplastic polyolefin (TPO)” refers to the conventional meaning of the term “thermoplastic polyolefin,” i.e. polyolefins that are thermoplastics. Examples of TPO's that are suitable for use include linear polyethylene, polyethylene, polybutenes, polypropylene, co-polymers, EPR or EPDM blended with PP or PE or copolymer, etc.

The term “UV absorber” refers to any conventional additive blended into a polymer to stabilize the adverse effects of light exposure, such as a loss of strength, degradation and decoloration. The use of a UV absorber may allow at least one layer of roofing membrane to exhibit good weathering characteristics. Examples of preferred UV absorbers additives include benzotriazole, benezophenones, hindered amine light stabilizers (HALS), non-interacting HALS (NOR-HALS), etc. The membranes, peripherals, flashings, universal flashings, other parts of a covering system, etc. may be made from one or more materials including one or more UV absorbers.

The term “UV screener” refers to a conventional additive blended into a polymer to reflect ultraviolet rays. Examples of preferred UV screener additives include TiO₂, carbon black, zinc oxide, etc. The membranes, peripherals, flashings, universal flashings, other parts of a covering system, etc. may be made from one or more materials including one or more UV screeners.

The term “fire retardants” or “FRs” refer to a conventional additives blended into a polymer to reduce the flammability of a polymer by slow down the rate of combustion. Examples of preferred FRs include magnesium hydroxide, brominated FR, SbO₃, etc. The membranes, peripherals, flashings, universal flashings, other parts of a covering system, etc. may be made from one or more materials including one or more fire retardants.

The term “dead load shear capable adhesive” refers to any adhesive having the property of reliably adhering the weight of a covering membrane, such as a roofing membrane and/or building peripheral at the upper and lower service temperatures of the covering system. A dead load sheer adhesive is capable of holding 20 grams per square inch at room temperature for 2 hours. Preferred dead load sheer capable adhesives are capable of holding 50 grams per square inch at 70° C. (158° F.) for 24 hrs. An example of a dead load shear capable adhesive is Adco PSA-3™ manufactured by Adco Products, Inc.

In one preferred embodiment, the present invention provides a roofing system in which all of the components are peel-and-stick, thereby providing a thermoplastic-type roofing system without the need for any hot air welds. Such a roofing system may be simple enough to install by non-professionals on jobs such as carport repair, mobile home re-roofing, etc. Even if hot air welding is used to weld together roofing membranes, using peel-and-stick peripherals greatly speeds up installation time of roofing peripherals.

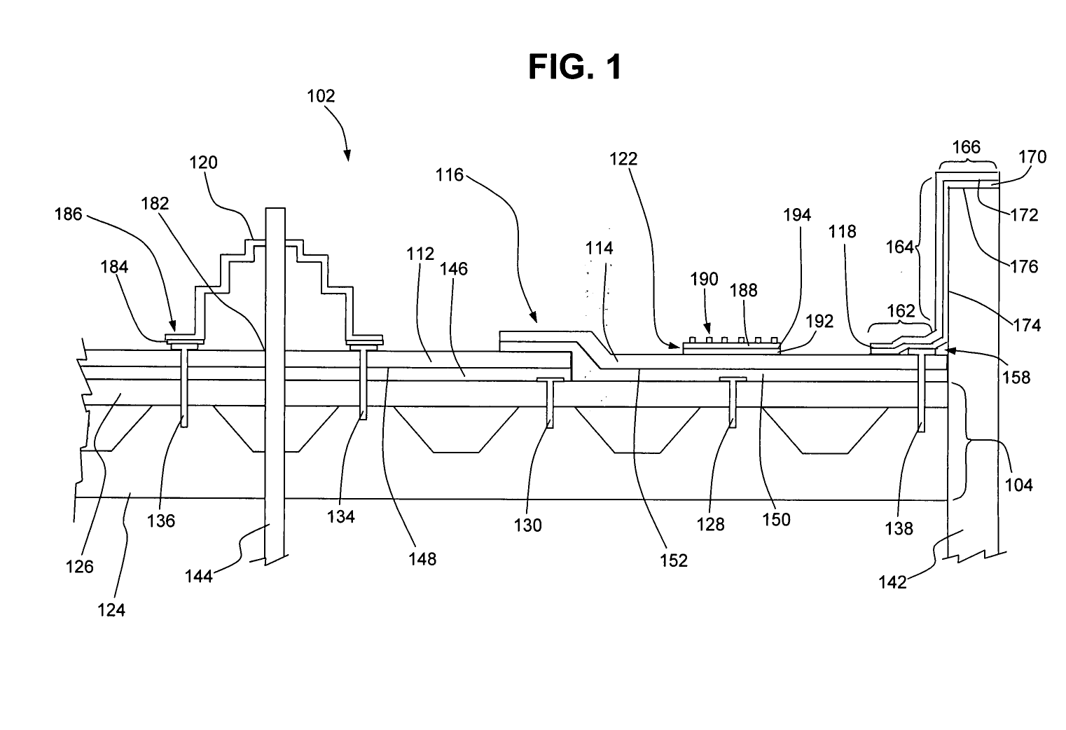

FIG. 1 illustrates a section of a peel-and-stick roofing system 102 mounted on a roof substrate 104. Roofing system 102 includes a roofing membrane 112, a roofing membrane 114 that overlaps roofing membrane 112 at an overlap region 116, a flashing 118, a pipe boot 120, and a walkway pad 122. Roof substrate 104 includes a roof deck 124 and an insulation board 126 held on roof deck 124 by short screws 128 and 130 and long screws 134, 136 and 138. Bordering roof deck 104 is a vertical wall 142 and extending through roof deck 104 is a vertical pipe 144.

Roofing membrane 112 is adhered to roof deck 104 by a dead load shear capable adhesive 146 that has been pre-applied to a backside 148 of roofing membrane 112. Roofing membrane 112 is additionally held to roof deck 104 by long screws 134 and 136. Roofing membrane 114 is adhered to roof deck 104 by a dead load shear capable adhesive 150 that has been pre-applied to a backside 152 of roofing membrane 114. Roofing membrane 114 is additionally held to roof deck 104 by long screw 138. In overlap region 116, roofing membrane 114 is adhered to roofing membrane 112 by adhesive 150.

Flashing 118 covers long screw 138, a joint region 158 where roof deck 104 and vertical wall 142 meet, and vertical wall 142 and provides protection from the elements. Flashing 118 includes a lower horizontal portion 162, a vertical portion 164 and an upper horizontal portion 166 and a dead load shear capable adhesive 170 coated on a backside 172 of flashing 118. Lower horizontal portion 162 covers long screw 138 and is adhered to roofing membrane 114. Vertical portion 164 is adhered to a side face 174 of vertical wall 142. Upper horizontal portion 166 is adhered to a horizontal top 176 of vertical wall 142.

Pipe boot 120 surrounds vertical pipe 144 and covers long screws 134 and 136 and opening 182 in roofing membrane 112 and provides protection from the elements. Pipe boot 120 includes a pressure sensitive adhesive 184 around a rim 186 of pipe boot 120 and adhesive 184 is used to adhere pipe boot 120 to roofing membrane 112. Prior to adhering pipe boot 120 to roofing membrane 112, adhesive 184 is covered by a release liner (not shown).

Preferred pipe boots may have a peel-and-stick configuration that allows the pipe boot to be adhered to a roofing membrane by removing a release liner and adhering the exposed adhesive to the roofing membrane. Suitable pipe boots includes the EPDM or TPO peel-and-stick pipe boots, with included clamping rings, made by GenFlex™.

Walkway pad 122 includes a thermoplastic mat 188 having a slip reducing surface 190 and a pressure sensitive adhesive 192 coated on a backside 194 of mat 188 to allow pad 122 to be adhered to roofing membrane 114. Prior to adhering pad 122 to roofing membrane 114, adhesive 192 is covered by a release liner (not shown).

Except for the use of a pressure sensitive adhesive, the walkway pad is similar to conventional walkway pads, such as the EPDM walkway pads sold by GenFlex™. Walkway pads may be mounted on roofs to allow access to mechanical equipment for maintenance.

Preferably, a roofing membrane used in a roofing system of the present invention is a peel-and-stick roofing membrane in which a pressure sensitive adhesive one at least one side of the membrane is protected by a release liner made of any suitable release liner material such as waxed paper, plastic, etc. treated with a release agent. Using a pressure sensitive adhesive and release liner allows easier storage and transportation of a roofing membrane.

Although pressure sensitive adhesives are only shown as being on a backside of the roofing membranes in FIG. 1, one or more sections of an upper side of the roofing membrane may also include a pressure sensitive adhesive. By removing a release liner on the pressure sensitive adhesive sections of an upper side of the roofing membrane, peripherals that do not have adhesives may be mounted on the roofing membrane. For example, if the roofing membrane 114 in FIG. 1 had included a peel-and-stick section on the upper side of the roofing membrane, the walkway pad mounted on the roofing membrane would not require its own pressure sensitive adhesive.

Although in FIG. 1, the overlapping roofing membranes are bonded together using dead load shear capable adhesive, in an alternative embodiment of the invention the roofing membranes may instead be welded together using a hot welding technique. When an adhesive is used to bond overlapping roofing membranes together, the adhesive may either be pre-applied to the edge region of the roofing membrane and preferably covered by a separate release liner that is removed just prior to bonding the overlapping membranes together. The adhesive in the edge region of the overlapping roofing membrane may or may not be the same adhesive used on the rest of the roofing membrane. Alternatively, the edge region of the overlapping roofing membrane may be free of adhesive prior to installation and the adhesive may be applied during installation. When hot welding is used, a portion of the overlapping roofing membrane is preferably not coated with the adhesive.

A preferred material for the insulation board shown in FIG. 1 is polyisocyanurate insulation board.

Although the flashing shown in FIG. 1 includes an adhesive on the entire backside of the flashing, some applications may not need to coat part of the backside. For example, a portion of the backside of the flashing may be uncoated with an adhesive to allow the flashing to be welded to a roofing membrane using hot welding or where the flashing is secured to a horizontal or vertical structure using conventional fastening devices such as screws, nails, etc. Also, although FIG. 1 only shows the use of adhesive to secure the flashing to the roofing membrane and vertical structure, the flashing may be additionally secured using conventional fastening devices such as screws, nails, etc.

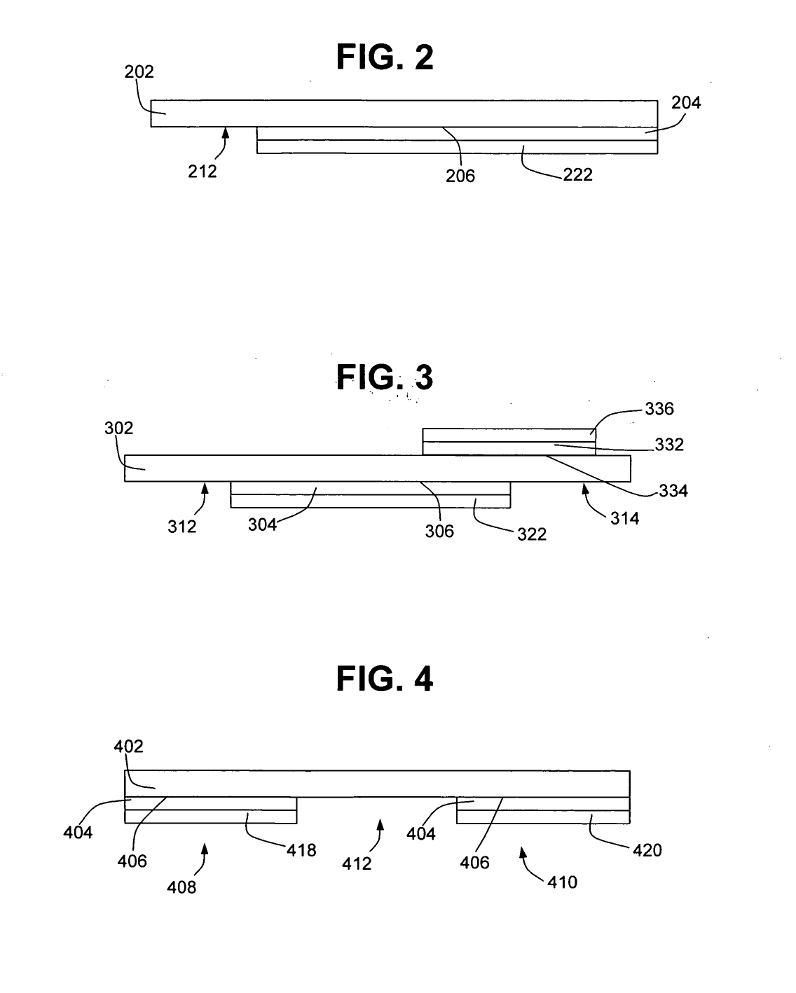

FIG. 2 illustrates a flashing 202 having a dead load shear capable adhesive 204 coated on a backside 206 of flashing 202. One end 212 of backside 206 is left uncoated with adhesive 204. A release liner 222 cover adhesive 204.

FIG. 3 illustrates a flashing 302 having a dead load shear capable adhesive 304 coated on a backside 306 of flashing 302. Ends 312 and 314 of backside 306 are left uncoated with adhesive 304. A release liner 322 covers adhesive 304. Flashing 302 also includes a dead load capable adhesive 332 on an upper side 334 of flashing 302. A release liner 336 covers adhesive 332. Adhesive 332 allows roofing peripherals (not shown) that do not include their own adhesive coating to be mounted on the flashing.

FIG. 4 illustrates a flashing 402 having a dead load shear capable adhesive 404 coated on a backside 406 of flashing 402 in two sections 408 and 410 of adhesive 404. Between sections 408 and 410 is an uncoated section 412. Release liners 418 and 420 cover sections 408 and 410, respectively, of adhesive 404.

Although only a few types of flashing are illustrated in FIGS. 2, 3 and 4, the flashing may have various shapes and having adhesive coated on the backside of the flashing in a variety of ways, including having the adhesive coated on the entire backside of the flashing. Flashing may include one or more preformed angle bend and may include materials to reinforce the flashing such as internal fabric or reinforcing layers.

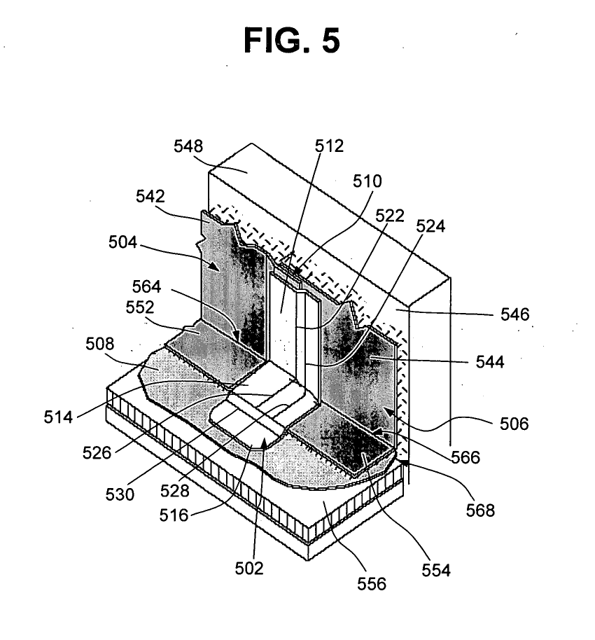

FIG. 5 illustrates a universal flashing 502 that is used in conjunction with two building structure surfaces that meet at right angles. Universal flashing 502 is adhered to an overlapping flashing 504, an overlapped flashing 506 and a covering membrane 508. Universal flashing 502 covers and seals an overlap region 510 where overlapping flashing 504 overlaps overlapped flashing 506. Universal flashing 502 includes a vertical portion 512, a horizontal portion 514, a flap portion 516 and bends 522, 524 and 526, 528 and 530. Vertical portion 512 and horizontal portion 514 are adhered to overlapping flashing 504 and overlapped flashing 506. Flap portion 516 is adhered to covering membrane 508. Overlapping flashing 504 is adhered to overlapped flashing 506 by a peel-and-stick adhesive in overlap region 510. A vertical portion 542 of overlapping flashing 504 and a vertical portion 544 of overlapped flashing 506 are adhered by a peel-and-stick adhesive to a vertical surface 546 of a building structure 548. A horizontal portion 552 of overlapping flashing 504 and a horizontal portion 554 of overlapped flashing 506 are adhered by a peel-and-stick adhesive to covering membrane 508, only a portion of which is shown in FIG. 5. Covering membrane 508 covers a horizontal surface 556 of building structure 548. Overlapping flashing 504 includes a bend 564 and overlapped flashing 506 includes a bend 566. Overlapping flashing 504 and overlapped flashing 506 seal a join region 568 where covering membrane 508 abuts vertical surface 546.

FIG. 6 illustrates an embodiment in which an oval universal flashing 602 is used in conjunction with an exterior corner 604 of a building structure 606. Building structure 606 includes a horizontal surface (not visible in FIG. 6) covered by a covering membrane 608 and a box-like vertical structure 610, extending through an opening (not visible in FIG. 6) in covering membrane 608, including and four vertical surfaces 612, 614, 616 and 618. Vertical surfaces 612, 614, 616 and 618 include respective top edge surfaces 622, 624, 626 and 628. A multiply bent flashing 630 covers vertical structures 612, 614, 616 and 618 and top edge surfaces 622, 624, 626 and 628. Prior cuts (not shown in FIG. 6) in multiply bent flashing 630 form bottom flaps 632 that are adhered by a peel-and-stick adhesive to covering membrane 608. Prior cuts (not shown in FIG. 6) in multiply bent flashing 630 form top flaps 634 that are adhered by a peel-and-stick adhesive to top edge surfaces 622, 624, 626 and 628. Multiply bent flashing 630 overlaps itself in an overlap region 642 forming a seam 644. Universal flashing includes bends 652, 654 and 656 and includes three portions vertical portion 662, vertical portion 664 and horizontal portion 666 that are in three planes that are orthogonal to each other. Vertical portion 662 extends vertically and is adhered to a side 672 of multiply bent flashing 630. Vertical portion 664 extends vertically and is adhered to a side 674 of multiply bent flashing 630. Horizontal portion 666 extends horizontally and is adhered to two bottom flaps 632 and to covering membrane 608. Universal flashing 602 covers and seals a join 676. Between top flaps 634 are seams 678.

An additional universal flashing, an additional flexible flashing, or an appropriately shaped semi-rigid flashing may be used to cover the other seams formed by the overlap region of the multiply bent flashing and the seams between the top flaps and other joins between the multiply bent covering flashing and the horizontal surface. Also, instead of the universal flashing shown in FIG. 6, a pre-shaped semi-rigid flashing could be substituted to cover and seal the corner.

FIG. 7 illustrates an embodiment in which a rectangular universal flashing 702 is used in conjunction with an interior corner 704 of a building structure 706. Universal flashing 702 is adhered to an overlapping flashing 708, an overlapped flashing 710 and a covering membrane 712. Overlapping flashing 708 is a preformed semi-rigid flashing shaped to fit into interior corner 704. Universal flashing 702 covers and seals an overlap region 714 where overlapping flashing 708 overlaps overlapped flashing 710. Universal flashing 702 includes a vertical portion 716, a horizontal portion 718 including a horizontal flap portion 720 and bends 722, 724 and 726 (as well as several bends not easily seen in FIG. 7). Bend 722 is between vertical portion 716 and horizontal portion 718 and bends 724 and 726 form are between horizontal flap portion and a based portion 728 of horizontal portion 718 Vertical portion 716 and horizontal portion 718 are adhered to overlapping flashing 708 and overlapped flashing 710. Flap portion 720 is adhered to covering membrane 712. Overlapping flashing 708 is adhered to overlapped flashing 710 by a peel-and-stick adhesive in overlap region 714. A vertical portion 742 of overlapping flashing 708 and a vertical portion 744 of overlapped flashing 710 are adhered by a peel-and-stick adhesive to vertical surfaces 746 and 748 of building structure 706. A horizontal portion 752 of overlapping flashing 708 and a horizontal portion 754 of overlapped flashing 710 are adhered by a peel-and-stick adhesive to covering membrane 712, only a portion of which is shown in FIG. 7. Covering membrane 712 covers a horizontal surface 756 of building structure 706. Overlapping flashing 708 includes a bend 764 and overlapped flashing 710 includes a bend 766. Overlapping flashing 708 and overlapped flashing 710 seal a join region (not visible in FIG. 7) where covering membrane 712 abuts a corner vertical surface 746. Overlapping flashing 708 also includes a bend 772 where overlapping flashing covers interior corner 704.

Prior to being adhered to a flashing, a covering membrane or a building structure surface, the peel-and-stick adhesives used to adhere flashings and universal flashings are preferably covered by a release line. Although the flashings and universal flashings illustrated in FIGS. 5, 6 and 7 are adhered using only peel-and-stick adhesive, the flashings and universal flashings may be adhered to one or more surfaces by hot air welding instead of by use of a peel-and-stick adhesive. When hot air welding is used to adhere a universal flashing to a surface, there is generally no adhesive on the underside of the flashing in the region that is adhered by hot air welding.

A universal flashing preferably may consist of a material such an uncured rubber, such as EPDM, that is capable of holding a shape into which the flashing may be bent. When using an uncured rubber, the uncured rubber may be cured after installation. The ability of a flashing to maintain a shape is particularly valuable when the flashing is used to cover and seal corner structures or other structures that require extensive bending of the flashing.

A preferred adhesive for use with a universal flashing is a butyl pressure sensitive adhesive.

A preferred thickness of a flashing may be 0.001 to 6.0 cm. A more preferred thickness of a flashing may be 0.01 to 3.0 cm. Yet another more preferred thickness of a flashing may be 0.1 to 1.0 cm.

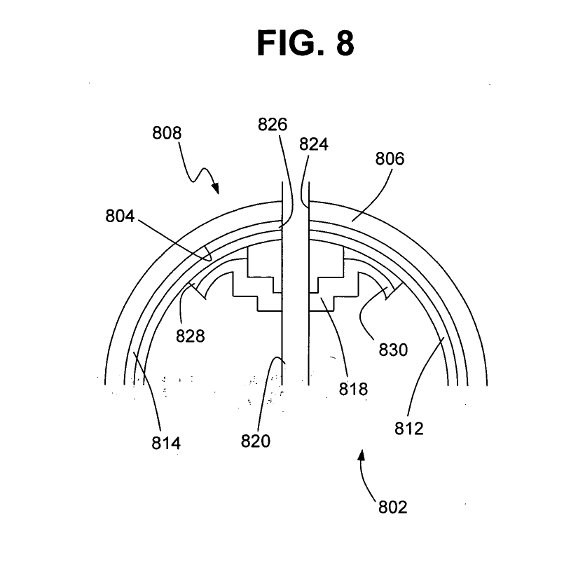

FIG. 8 illustrates in simplified form a section of a peel-and-stick covering system 802 that is applied to an underside 804 of an upper portion 806 of a tunnel 808. Covering system 802 includes a membrane 812 and a pressure sensitive adhesive 814 that adheres membrane 812 to tunnel 808. Prior to adhering membrane 812 to tunnel 808, adhesive 814 is covered by a release liner (not shown). Covering system 802 also includes a pipe boot 818 that surrounds a vertical pipe 820 that extends through an opening 824 in tunnel 808 and opening 826 in membrane 812. Pipe boot 818 includes a pressure sensitive adhesive 828 around a rim 830 of pipe boot 818. Adhesive 828 is used to adhere pipe boot 818 to membrane 812. Prior to adhering pipe boot 822 to membrane 812, adhesive 828 is covered by a release liner (not shown).

The rim of the pipe boot and parts building peripherals used with covering systems employed on curved or contoured surfaces, such as the curved tunnel surface of FIG. 8, preferably either shaped to be capable of being mounted on a curved surface or are flexible enough to be mounted on a curved surface.

Although for simplicity only one section of membrane is shown being used in FIG. 8, several overlapping membranes can be used in covering systems of the type shown in FIG. 8, similar to the way that overlapping membranes are used in the roofing/covering system of FIG. 1. Also, as in the covering system of FIG. 1, covering systems of the type shown in FIG. 8 may include several building peripherals.

The covering system may have particular advantages when being applied to a surface from below, as shown in FIG. 8, because the covering system is provided with an adhesive that immediately adheres the covering system to the surface.

A preferred dead load shear capable adhesive for use with the covering system and flashing is Adco PSA-3™ manufactured by Adco Products, Inc. Adco PSA-3™. Adco PSA-3™ is a pressure sensitive adhesive composition comprising styrene-ethylene-butylene-styrene (SEBS), a tackifying endblock resin such as a cumarone-indene resin and a tackifying midblock resin such as a terpene resin. Other preferred dead load shear capable adhesives include: butyl-based adhesives, EPDM-based adhesives, acrylic adhesives, styrene-butadiene adhesives, polyisobutylene adhesives, ethylene vinyl acetate adhesives, etc.

One type of dead load shear capable adhesive may be used for all of the roofing membranes and roofing peripherals of a system, or different adhesives may be used for different components. Also, different adhesives may be used on different sections of a component. For example, a stronger adhesive or may more moisture resistant adhesive may be used to adhere two overlapping membranes to each other while a weaker and possibly cheaper adhesive may be used to adhere the non-overlapping portion of the roofing membrane to a roof substrate. The adhesive used for the seam may or may not be SEBS.

A preferred thickness of a dead load shear capable adhesive may be 0.001 to 0.5 cm. A more preferred thickness of a dead load shear capable adhesive may be 0.01 to 0.25 cm. Yet another more preferred thickness of a dead load shear capable adhesive may be 0.1 to 0.2 cm.

Although for convenience, the covering system of the present invention is only described above as being applied from above to a horizontal surface or from below to a curved surface, the covering system may also be used on slanted surfaces, such as slanted or peaked roofs, vertical surfaces, such as walls, chimneys, combinations of vertical and horizontal surfaces, etc., curved surfaces such as culverts, or contoured surfaces, such as terra cotta roofs, or may be applied from below to horizontal and vertical surfaces such as roof overhangs or various curved or contoured surfaces.

The parts of the covering system of the present invention may be made colored or made of transparent materials to be less noticeable when applied to a building structure.

Also, although only a few types of building structures are depicted as being covered in the embodiments of the present invention described above and illustrated in the drawings, the covering system of the present invention may be used on a variety of building structures.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. A covering product comprising:
a membrane comprised of a thermoplastic; and
a dead load shear capable adhesive on at least a portion of a backside of said membrane in a quantity sufficient to adhere a majority of said membrane to a building structure.

2. The product of claim 1, wherein said membrane includes a UV absorber and/or a UV screener.

3. The product of claim 1, wherein said membrane includes a fire retardant.

4. The product of claim 1, wherein said product further comprises a release liner that is releasably bonded to said adhesive.

5. The product of claim 1, wherein said product is adhered to a building structure.

6. The product of claim 1, wherein said adhesive comprises ethylene-butylene-styrene.

7. The product of claim 1, wherein said product is a roofing membrane.

8. The product of claim 1, wherein said product is adhered by a building structure by said adhesive.

9. A method for installing a covering system comprising the following steps:
(a) providing a substrate; and
(b) adhering a first membrane to a building structure using a first adhesive bonded to at least a portion of a backside of said first membrane, wherein said first membrane is comprised of a thermoplastic and said first adhesive comprises a dead load shear capable adhesive and wherein a majority of the surface area of said first membrane is adhered to said building structure.

10. The method of claim 9, further comprising the step of removing a first release liner covering said first adhesive prior to step (b).

11. The method of claim 9, wherein said first membrane includes a UV absorber and/or a UV screener.

12. The method of claim 9, wherein said first membrane includes a fire retardant.

13. The method of claim 9, wherein said first adhesive comprises ethylene-butylene-styrene.

14. The method of claim 9, further comprising the following steps:
(c) removing a second release liner from a backside of at least one roofing peripheral to expose a second adhesive on at least a portion of said backside of said roofing peripheral; and
(d) adhering said building structure peripheral to said first membrane using said second adhesive.

15. The method of claim 9, further comprising the following steps:
(c) adhering a second membrane on said building structure using said first adhesive bonded to at least a portion of a backside of said second membrane, wherein said first membrane is comprised of a thermoplastic;
(d) overlapping an edge region of said second membrane over an overlapped section of an upper side of said first membrane; and
(e) joining said edge region to said overlapped section.

16. The method of claim 15, wherein said edge region has said first adhesive pre-applied thereon and wherein said edge region is joined to said overlapped section using said first adhesive.

17. A covering product comprising:
a universal flashing; and
a dead load shear capable adhesive on at least a portion of a backside of said universal flashing in a quantity sufficient to adhere a majority of said universal flashing to a building structure or a thermoplastic membrane.

18. A method for installing a flashing comprising:
providing a universal flashing; and
adhering said universal flashing to at least two surfaces that are at angle to each other, wherein said flashing is adhered to a building structure and/or a membrane adhered to said building structure.

19. The method of claim 17, wherein said universal flashing is adhered to at least three surfaces that are at angles with respect to each other.

20. The method of claim 19, wherein at least one of said three surfaces is part of an exterior corner of said building structure.
